(19) United States
(12) Patent Application Publication
(10) Pub. No.: US 2001/0014973 A1
(43) Pub. Date: Aug. 16, 2001

(54) Data processing device for generation of database storing picture data

(76) Inventor: Motoyoshi Suzuki, Tokyo (JP)

Correspondence Address: STAAS & HALSEY, Suite 500, 700 Eleventh Street, N.W., Washington, DC, 20001, US

(21) Appl. No.: 09/750,049

(22) Filed: Dec. 29, 2000

(30) Foreign Application Priority Data
Feb. 15, 2000 (JP) 2000-037189

(51) Int. Cl. H04N 7/16; H04N 7/173

(52) U.S. Cl. 725/88

(57) ABSTRACT

Picture data is obtained by segmenting data in time unit for each of the desired scenes (for example, for each delivery of a ball in a baseball game) of a subject by controlling the drive of a video camera by a personal computer. Using the personal computer, the time-segmented picture data is obtained and various retrieval data about the picture data is input. Using another computer for editing pictures, the picture data is associated with the retrieval data, and stored as a database. Thus, the obtained database can be viewed by being distributed in CR-ROM as necessary, and through a network.

### BACKGROUND OF THE INVENTION

1. Field of the Invention

The present invention relates to a data processing device for storing various picture data about a subject as a database.

The present invention processes picture data in various fields, and especially makes picture data of various sports such as baseball, soccer, tennis, golf, etc. be retrieved and viewed. Otherwise, the present invention is applicable in retrieving and viewing picture data in other fields such as a fashion show, etc.

2. Description of the Related Art

For example, considering a professional baseball team, there can arise a request to refer to or study for future games the previous games, the performances of various players in the games, etc. In this case, normally, the contents of the games which are broadcast on TV are recorded by a video recorder, or the games are shot using a personal video camera, and a video tape is stored for future use so that the games can be played back later as necessary.

However, when such a video tape is used in displaying a desired picture on the screen, it is necessary to forward or rewind the video tape while watching the screen until the desired picture can be correctly displayed on the screen. In addition, when a user wants to repeatedly see a specific picture, the user has to repeat the forwarding and rewinding operations each time, thereby requiring much labor and time. As a result, the process is inefficiently performed.

### SUMMARY OF THE INVENTION

The present invention aims at solving the above mentioned problems, and providing a picture data process system capable of immediately retrieving picture data of a desired scene to be viewed by a user.

To attain the above mentioned purpose, the present invention is configured as follows.

(1) An embodiment of the data processing device according to the present invention includes: an input unit for inputting segmentation information indicating a time slice for each piece of picture data continuous in time series about a subject, and retrieval data indicating the attribute of the subject corresponding to each piece of picture data assigned to each time slice; and a storage unit for segmenting the above mentioned continuous picture data according to the segmentation information, associating each piece of picture data obtained by segmenting the data with the corresponding retrieval data, and storing the associated data.

With the configuration, the continuous picture data in time series about a subject is not stored in whole, but is segmented in time unit, and each piece of the segmented picture data is associated with corresponding retrieval data and is then stored. Using the obtained database, desired picture data satisfying a predetermined retrieval condition can be immediately retrieved and viewed only by determining the retrieval condition as necessary.

(2) Another embodiment of the data processing device according to the present invention includes: an input unit for inputting common segmentation information indicating a time slice for plural different pieces of picture data continuous in time series about a subject, and retrieval data indicating the attribute of the subject corresponding to each piece of picture data assigned to each time slice; and a storage unit for segmenting the above mentioned plural pieces of continuous picture data according to the segmentation information, associating each piece of picture data obtained by segmenting the data with the corresponding retrieval data, and storing the associated data.

The configuration is obtained by segmenting plural different pieces of picture data continuous in time series, and is based on, for example, the process of capturing one subject from plural directions.

With the configuration, plural pieces of picture data captured from different directions can be segmented in time series, associated with corresponding retrieval data, and stored as a database. Therefore, using the database, various picture data can be immediately provided.

In the descriptions in (1) and (2) above, the subject and the retrieval data can refer to a number of items. For example, (a) the above mentioned subject can be a ball game player, and the retrieval data can contain the information about a delivery of a ball; (b) the above mentioned subject is a ball game player, and the above mentioned retrieval data can contain the information about the course of a ball; and (c) the above mentioned subject can be a ball game player, and the above mentioned retrieval data can contain the information about the state of a play in the above mentioned ball game.

The above mentioned segmentation information can refer to a number of items. For example, it can be a record starting time and a record ending time expressed as an absolute time, and more specifically a record starting time and a record ending time expressed as an absolute time of a play for each delivery of a ball performed by a ball game player.

(3) The present invention is also applied to a computer-readable storage medium storing a computer program. As an embodiment, the program includes: an input unit for inputting retrieval data containing the segmentation information about corresponding picture data continuous in time series about a subject; and a storage unit for segmenting the above mentioned continuous picture data according to the segmentation information about the picture data, and storing the segmented picture data after being associated with the above mentioned retrieval data.

The descriptions in (1) above hold true with the case in which the present invention is realized by the storage medium with the above mentioned configuration.

(4) As another embodiment of a computer-readable storage medium according to the present invention, the above mentioned program includes: an input unit for inputting retrieval data containing the segmentation information about plural pieces of corresponding picture data continuous in time series about a subject; and a storage unit for segmenting the above mentioned plural pieces of continuous picture data obtained by capturing a subject from a plurality of directions according to the segmentation information, and storing the segmented picture data after being associated with the above mentioned retrieval data.

The descriptions in (2) above hold true with the case in which the present invention is realized by the storage medium with the above mentioned configuration.

The present invention can also realize various configurations and embodiments within the range of the gist of the present invention.

The present invention can also obtain preferable results from the processes of the picture data of the players of ball games such as baseball, soccer, tennis, golf, etc., but is not limited to these applications.

That is, the present invention can also be applied to many fields different from the above mentioned sports. For example, it can be applied to a fashion show in which a model, etc. is captured as a subject. That is, the present invention can be applied to any field when a database is generated by obtaining picture data segmented in time unit for each desired scene from continuous pictures (animation) in time series about a subject.

### BRIEF DESCRIPTION OF THE DRAWINGS

The foregoing and other objects, features and advantages will be apparent from the following more particular description of preferred embodiments of the invention as illustrated in the accompanying drawings.

FIG. 1 show the entire flow of the picture data retrieval and distribution system to a part of which the data processing device according to an embodiment of the present invention is applied;

FIG. 2 shows the configuration of the appliances of the picture data retrieval and distribution system shown in FIG. 1;

FIG. 3 shows an entire image of the present system in which the data processing device according to an embodiment of the present invention is applied to a baseball game;

FIG. 4 is a flowchart of the operation procedure of a picture capturing process and retrieval information inputting process in the data processing device according to an embodiment of the present invention;

FIG. 5 shows an example of a game information setting screen;

FIG. 6 shows an example of the retrieval information input screen;

FIG. 7 shows the file format of a retrieval information/picture management database;

FIG. 8 is a flowchart of the operation procedure of capturing a picture and generating a database in the data processing device according to an embodiment of the present invention;

FIG. 9 shows an example of the capturing process screen;

FIG. 10 shows an example of the picture entry screen (main screen);

FIG. 11 shows an example of the picture entry screen (initialization screen);

FIG. 12 shows a general image of the process of entering pictures of a plurality of video appliances by automatically segmenting them;

FIG. 13 shows the outline of a changing image as data format from the picture capturing process to the database generating process;

FIG. 14 shows a general image of the present invention when cooperating with this listing view systems; and

FIG. 15 shows an example of a hardware configuration required when the present invention is realized by a program.

### DESCRIPTION OF THE PREFERRED EMBODIMENTS

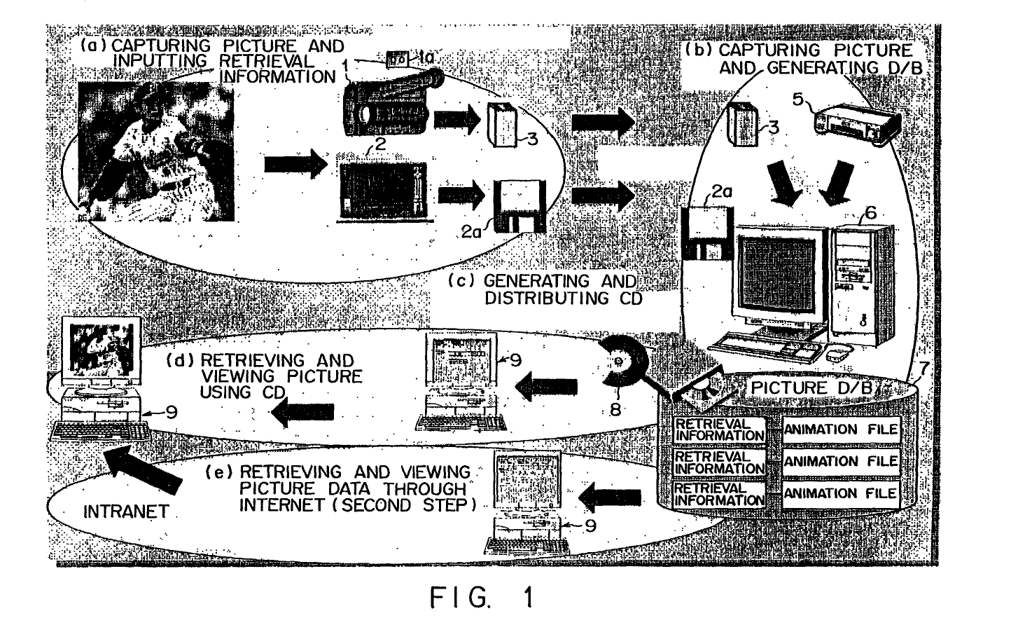

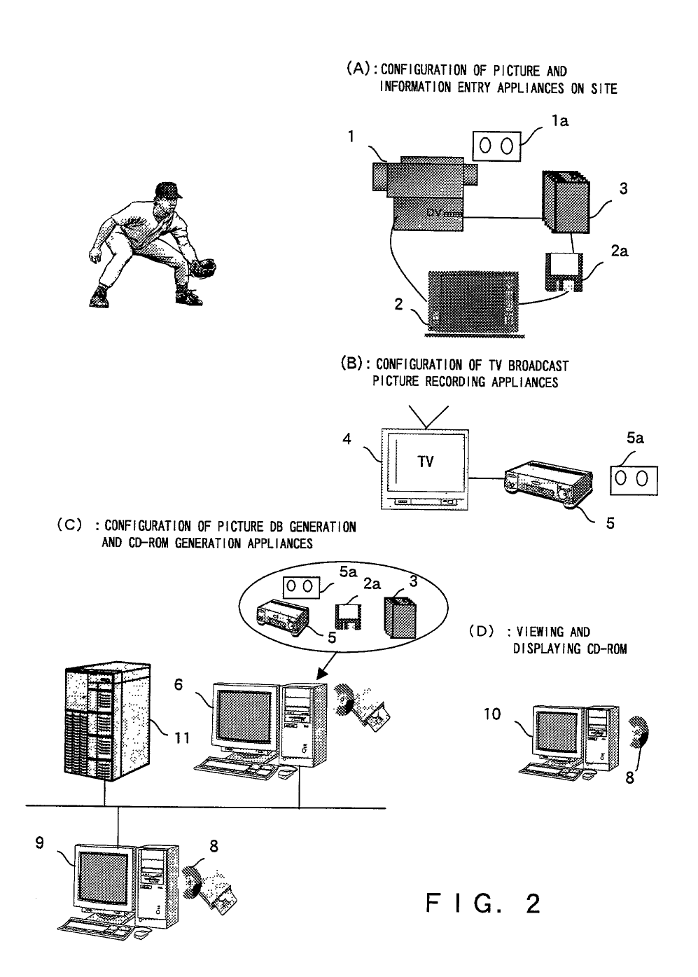

The embodiments of the present invention are described below by referring to the attached drawings. The picture data retrieval and distributing system shown in FIGS. 1 and 2 is a practical example for support of a professional baseball team. Therefore, the location is a ball park in which a game is performed, and the picture data of a desired scene in a baseball game is stored in a database.

First, the entire flow of the process performed by the picture data retrieval and distribution system is simply described below by referring to FIGS. 1 and 2. The following items (a) through (e) respectively correspond to (a) through (e) shown in FIG. 1.

(a) Taking a picture and inputting retrieval information

A flow of a baseball game currently being performed is taken by a video camera (especially a digital video camera) 1. At this time, as shown in (A) in FIG. 2, the video camera 1 is set to be driven and controlled by a personal computer 2, and the personal computer 2 is operated such that only the picture data of a desired scene can be recorded by a digital recording device (DRD) 3. Picture data of a desired scene refers to, for example, picture data in a ball unit (that is, a series of movements of a ball from the beginning to the end represented by ‘a delivery of a ball by a pitcher’, ‘the ball hit by a batter’, and ‘a result’, etc.).

In this case, retrieval data (for example, the name of a pitcher, the name of a catcher, the name of a batter, the type of delivery, etc.) indicating the attribute of a subject in each scene is input in the range of predetermined contents on the retrieval information input screen displayed on the personal computer 2. The data is stored in a floppy disk 2a, etc. It is desired that the video camera 1 is driven and controlled (for the start and the end of the recording process) on the above mentioned retrieval information input screen.

It is desired that the personal computer 2 can be a portable and operable notebook which can receive data input with a pen and can be easily carried to a location.

The picture data output from the video camera 1 is recorded by the digital recording device 3, and simultaneously the video camera 1 can record the data on a video tape (digital video tape) 1a.

Furthermore, there can be one or more video cameras 1 mounted at different places so that plural pieces of picture data can be simultaneously obtained for one subject. In this case, one video camera 1 is driven and controlled by the personal computer 2, and other video cameras are set to obtain picture data in time series from the start to the end of a game.

Since a professional baseball game is normally broadcast on TV, it is also desired that, as shown in (B) in FIG. 2, a video deck 5 records the picture displayed on a television 4 currently receiving the picture of the baseball game, and stores the picture data on a video tape 5a.

(b) Capturing a picture and generating a database (D/B)

The picture data of each scene obtained as described in (a) above, and the retrieval data input in (a) above are associated with each other, and stored as a database. The operation is performed by a large personal computer 6 functioning as a picture edition/CD-R management generation terminal and a picture management server 11 connected to the terminal through a network.

At this time, as described in (a) above, if there is picture data serially recorded for the entire game by the video cameras other than the video camera 1, and the video deck 5 for recording data received on TV, then an editing process is performed such that only the picture data of a desired scene can be extracted from the series of picture data. This editing process can be performed by fetching the portion corresponding to the picture data (that is, the picture data segmented by each of the desired scenes) recorded by the digital recording device 3. In this editing process, the entire picture data is represented as picture data segmented for each of the desired scenes (for example, for each delivery of a ball). The editing process can also be performed by the personal computer 6 and the picture management server 11.

Then, the individually obtained picture data is converted into animation files in, for example, an MPEG 1 format by the personal computer 6 and the picture management server 11. They are associated with the retrieval data (retrieval information) stored in the floppy disk 2a, etc., and are stored together as a picture database in, for example, the picture management server 11. Instead of the above mentioned process, it is obviously possible that each piece of picture data is converted into a file after the picture data, which has not been converted into a file, is associated and stored with the related retrieval data.

(c) Generating and distributing CD-ROM

At a request from a user (for example, a baseball player) to view the picture data in the database, a desired condition (for example, for a pitcher, for a batter, etc.) is set as a retrieval condition, and all animation files satisfying the retrieval condition are extracted from the picture database 7. Then, a CD-ROM 8 can be generated by setting on the CD-R the extracted animation files and the retrieval condition which has been converted into a file. This operation is performed by the domain server/CD-ROM generation terminal 9 as shown in (C) in FIG. 2.

Thus, the obtained CD-ROM 8 is distributed to the above mentioned user who requests to view the picture data.

(d) Retrieving and viewing picture using CD-ROM

A user who requests to view picture data as shown in (D) in FIG. 2 can view the data on a personal computer 10 available by the user using the CD-ROM 8 distributed as described in (c) above.

In this case, it is desired that a retrieval screen is set to be automatically activated when the CD-ROM 8 is connected to the personal computer 10 so that desired picture data satisfying the retrieval condition can be viewed only by selecting necessary retrieval condition on the retrieval screen.

(e) Retrieving and viewing picture data through Internet

Instead of generating and viewing the CD-ROM as described in (c) and (d) above, desired picture data can be retrieved and viewed through a computer network such as Internet, Intranet, etc.

In this case, a user who requests to view picture data connects the personal computer 10 to the network in advance, and inputs an ID and a password, thereby obtaining permission to retrieve and view data. After obtaining the permission, a retrieval screen is set to be displayed. It is preferable that desired picture data satisfying a retrieval condition can be viewed only by selecting a necessary retrieval condition on the retrieval screen. This function is mainly performed by the picture management server 11 shown in (C) in FIG. 2.

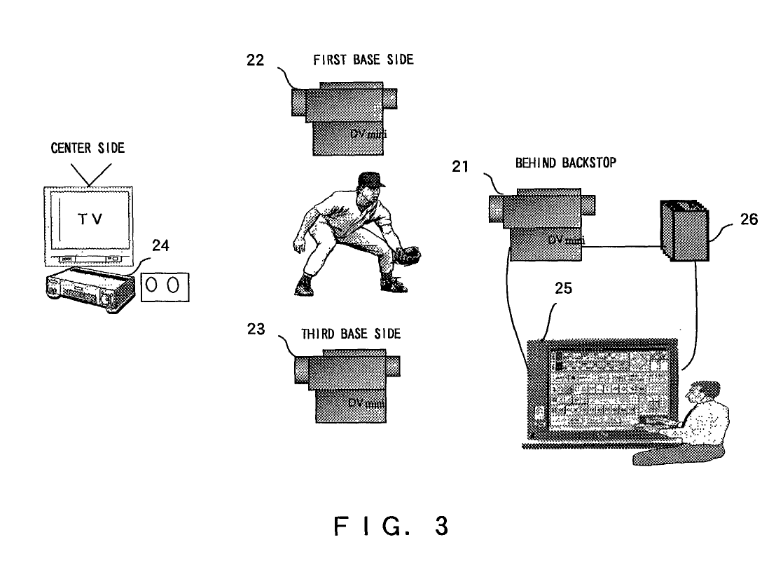

The data processing device (described in (a) and (b) above) according to an embodiment of the present invention is described furthermore in detail by referring to FIGS. 3 through 13.

FIG. 3 shows the entire image of the present system when a plurality of cameras are used to record a baseball game. In FIG. 3, the flow of a baseball game being performed is taken by a first, a second, and a third video cameras 21, 22, and 23, and also a video deck 24 records the picture being broadcast on TV. Otherwise, only the first video camera 21 is driven and controlled by a personal computer 25 to allow a recording device 26 to record the picture data for each of the desired scenes. The video camera 21, the personal computer 25, and the recording device 26 respectively correspond to the video camera 1, the personal computer 2, and the digital recording device 3 shown in (A) in FIG. 2. In this example, the three video cameras 21, 22, and 23 are mounted behind the backstop, on the first base side, and the third base side, and the game is broadcast on TV from the center field side.

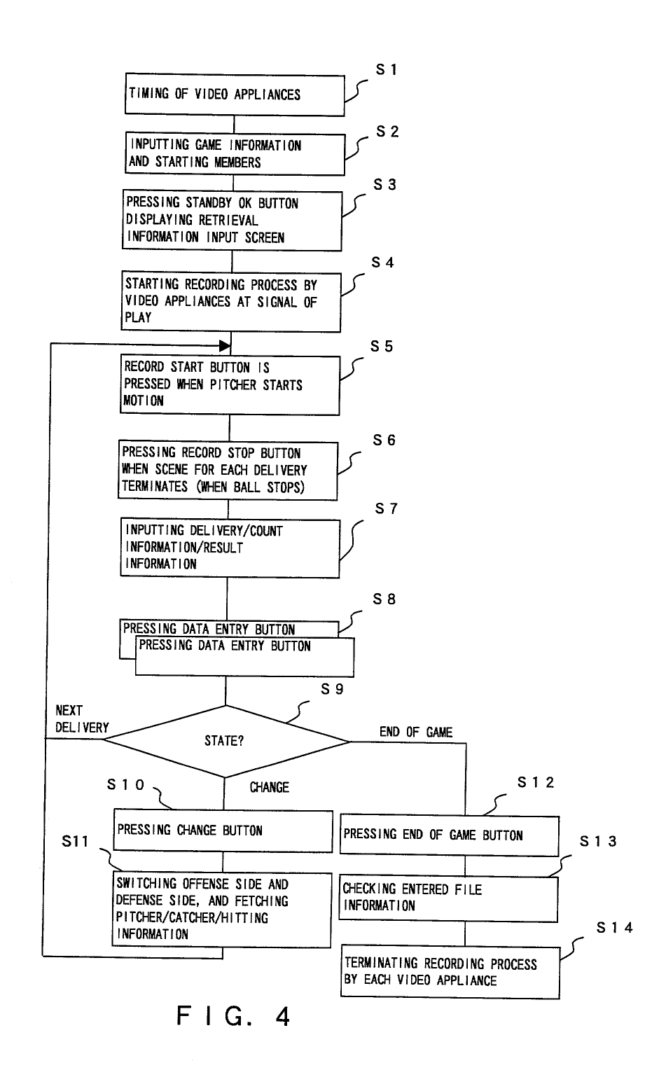

First, as described in (a) above, the procedure of the operations performed when a picture is taken and retrieval information is input is described below by referring to FIG. 4.

(a1) First, the time is set for the video appliances such as the video cameras 21, 22, 23, etc. (step S1). The time setting is required to associate various pieces of picture data obtained by the video appliances with one another correctly in time.

(a2) The personal computer 25 displays a game information setting screen, and game information, starting members, etc. are input on the screen (step S2).

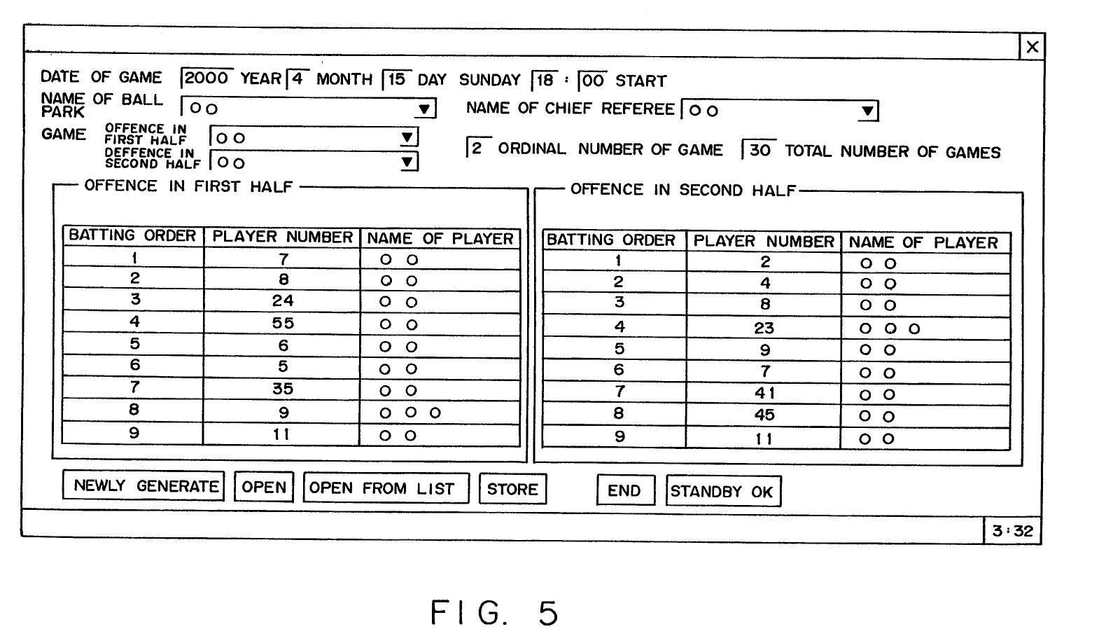

FIG. 5 shows an example of the game information setting screen. The features of the screen are briefly described below.

A ‘date of game (date and day of week)’ and a ‘starting time’ are displayed by invoking the built-in timer when the system is activated. They can be manually input and changed.

A ‘name of ball park’ is selected from a predetermined ball park name group. List data is read from a ball park master, which is a database of ball parks, when the system is activated. The data can be manually input.

A ‘name of chief referee’ is selected from a predetermined chief referee name group. List data is read from a chief referee master, which is a database of chef-referees, when the system is activated. The data can be manually input.

‘Names of teams playing offense in the first and second half of an inning’ are selected from a predetermined team name group. List data is read from a team master, which is a database of baseball teams, when the system is activated. The data can be manually input.

An ‘ordinal number’ of the game and the ‘accumulated number of games’ are manually input.

The names of teams selected in the game column are displayed in the ‘offense in the first half of an inning’ column and ‘offense in the second half of an inning’ column. In these columns, the starting members of the teams are set.

A number is input in a ‘player's number’ column. When the focus is moved, the corresponding name of the player is displayed.

A ‘name of a player’ is read from the player master, which is a database of players, when the system is activated.

(a3) The ‘OK’ button shown on the above mentioned game information setting screen (FIG. 5) is pressed. Then, a retrieval information input screen replaces the game information setting screen (step S3).

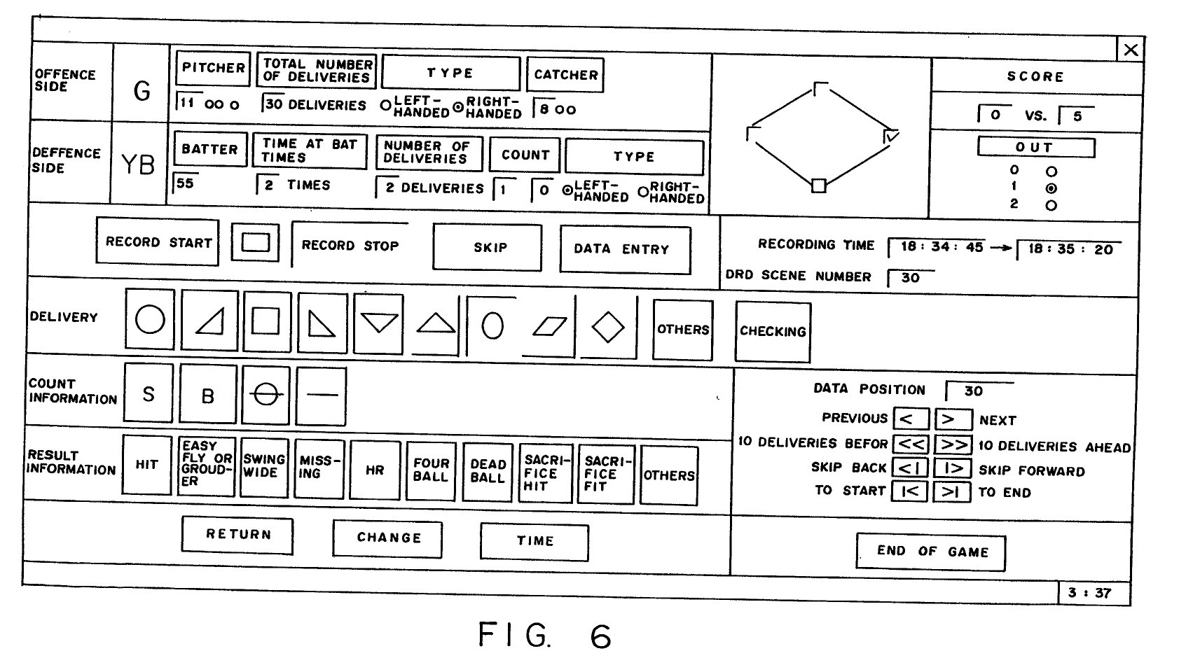

FIG. 6 shows an example of the above mentioned retrieval information input screen. The features of the screen are briefly described below.

The abbreviated names of the teams are displayed in the columns of ‘defense’ and ‘offense’.

The player numbers of the pitcher and the catcher of the offense are those entered as the starting members when the initial screen is displayed. The player names are automatically displayed. When a plurality of pitchers or catchers are entered as the starting members, those assigned larger ordinal numbers in the batting order are displayed.

A ‘total number of deliveries’ is automatically counted when a ‘data entry’ or ‘skip’ button is pressed. However, a checking pitch is not counted. The number can be manually amended.

When a ‘pitcher’ is replaced, the player number of a replacing player is input. The player name is automatically displayed. At this time, the ‘total number of deliveries’ is cleared.

A ‘type’ contains a left-hand delivery or a right-hand delivery. The default is the value in the player master.

When a ‘catcher’ is replaced, the player number of a replacing player is input. The player name is automatically displayed.

The numbers and the names of the players of the ‘offense’ are automatically displayed in the batting order. An amendment can be made by inputting the player number of a batter. At this time, the player name can be automatically displayed.

When a ‘batter’ is changed, the ‘number of times at bat’ and the ‘number of deliveries’ are cleared, but the ‘count’ is maintained.

The ‘number of times at bat’ is automatically counted and displayed as the number of times at bat of a player. The value can be manually amended.

The ‘number of deliveries’ is automatically counted and displayed for a batter. The value can be manually amended. The ‘number of deliveries’ is not cleared when a pitcher is replaced.

The ‘count’ indicates the number of strikes on the left, and the number of balls on the right. When the ‘B’ button of the ‘count information’ is pressed, the number of ‘balls’ is increased. When other buttons are selected, the number of ‘strikes’ is increased. For a foul, the number of strikes is increased up to 2 strikes.

The ‘runner position’ information is obtained by manually specifying the position of a runner. When a check box is clicked, a check mark is displayed to indicate the existence of a runner. When it is clicked again, the indication is cleared.

The ‘score’ information is manually input. The count for the offense in the first half inning is input on the left, and the count for the offense in the second half inning is input on the right.

An out count is manually input in the ‘OUT’ column. It is cleared by pressing the ‘change’ button.

When the ‘start of record’ button is pressed, data is recorded by the video camera 21 and the recording device 26 shown in FIG. 3. During the recording process, the indicator beside the ‘start of record’ button turns to red. When the recording process is started, the starting time is displayed in the ‘recording time’ column.

When the ‘stop of record’ button is pressed, the recording process performed by the video camera 21 and the recording device 26 shown in FIG. 3 is suspended, and the end of record time is displayed.

When the recording process is completed, the ‘type of delivery’ and the ‘count information’ or the ‘result information’ for the delivery are entered.

The ‘type of delivery’ selects the type of delivery by the pitcher. However, when the ‘check’ button is pressed, the total number of deliveries and the number of deliveries are not counted. The ‘type of delivery’ is selected from among various symbols one-to-one corresponding to the type of deliveries (straight, shoot, curve, slider, fork, change-up, sinker, palm, knuckle, etc.).

The course of a pitched ball can be selected although it is not shown in the drawings. The ‘course of a ball’ is expressed by a combination of left and right information (in baseball, insider, center, and outsider) and high and low information (in baseball, high, middle, and low). Various symbols one-to-one corresponding to these combinations are prepared, and a desired course can be selected from among the symbols.

The ‘count information’ is the information about the action against a pitched ball (missing a strike, leaving a ball, swing wide, and foul). For a target batter, data is input when the next delivery is started.

The ‘result information’ is the final result of a batter for the target time at bat. That is, It indicates that the batter can be the next batter in the current inning, or the offense side is changed.

In the present specification, the ‘play state’ refers to the information about one of, a combination of, or all of the ‘pitcher’, ‘batter’, ‘total number of deliveries, ‘number of times at bat’, ‘number of deliveries’, ‘count’, ‘runner position’, ‘OUT’, and ‘result information’.

The ‘attribute of subject’ refers to the information about the attribute of a subject including one of, a combination of, or all of the ‘type of delivery’, ‘course of a ball’, and ‘play state’.

Furthermore, a ‘subject’ is selected from among players (for example, a pitcher, other players) depending on the purpose of the use of the present invention. For example, when the habits of an opposing pitcher are to be checked to increase base stealing, the pitcher is the main ‘subject’. When a batter intends to overcome a difficult course and type of delivery, the batter is the main ‘subject’.

The ‘data entry’ button enters each piece of input retrieval information. If the ‘count information’ is selected when the ‘data entry’ button is pressed, the next delivery is expected. On the other hand, if the ‘result information’ is selected and the offense side is not changed, then the next batter is automatically displayed.

The ‘skip’ button is used when the ‘type of delivery’, ‘count information’, ‘result information’, etc. are not input in time. When the ‘skip button’ is pressed, a skip mark is added to the data for use later when any of them is input again.

When the ‘change’ button is pressed, the offense and defense sides are switched, and the target player information is automatically displayed.

The ‘end of game’ button closed the retrieval information input screen, thereby terminating the system.

(a4) At the signal of ‘Play!’ of a game, the video appliances (the video cameras 22 and 23, and the video deck 24) except the video camera 21 start recording data (step S4).

(a5) When a desired scene starts (when the pitching motion of the pitcher start if a scene for each delivery is requested as described above), the ‘start of record’ button is pressed on the above mentioned retrieval information input screen (FIG. 6) (step S5). Thus, the recording process by the video camera 21 and the recording device 26 is started.

(a6) When the scene for each delivery (movement of a ball of each delivery) is completed, the ‘stop of record’ button is pressed on the above mentioned retrieval information input screen (FIG. 6) (step S6). Thus, the recording process by the video camera 21 and the recording device 26 is stopped, and the recording device 26 records the picture data segmented for each delivery.

(a7) On the above mentioned retrieval information input screen (FIG. 6), for example, the ‘type of delivery’, ‘count information’, ‘result information’, etc. are input as the retrieval information relating to the recorded scenes (step S7).

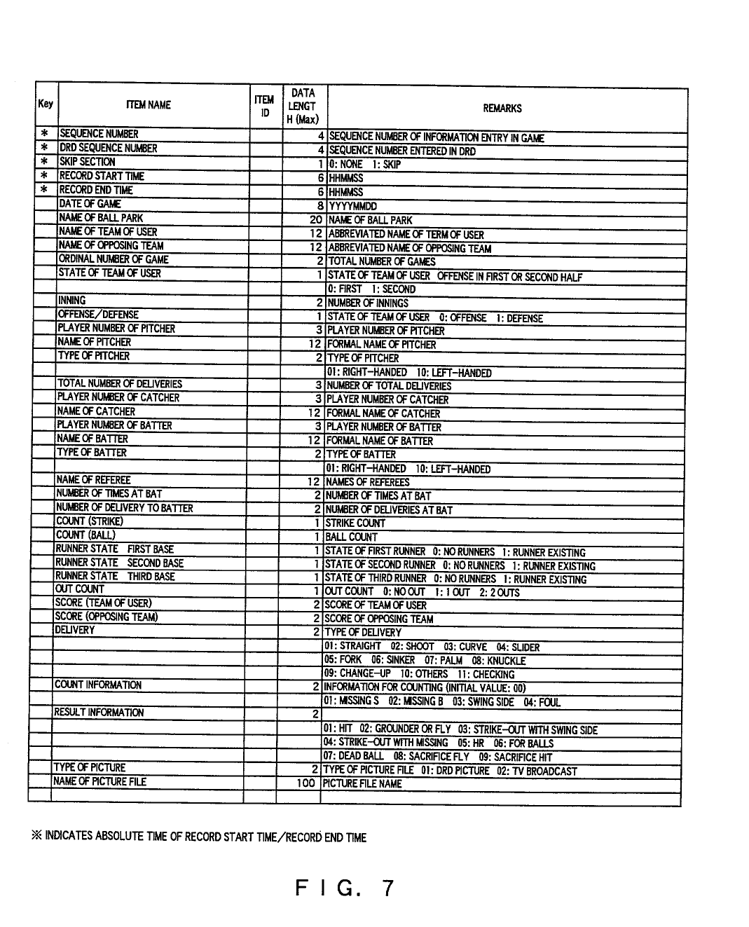

(a8) When all retrieval data is completely input, the ‘data entry’ button is pressed on the above mentioned retrieval information input screen (FIG. 6) (step S8). Thus, the retrieval information relating to the picture data for each scene is entered on the floppy disk (floppy disk 2a shown in FIG. 2), etc. as the picture management database in the file format as shown in FIG. 7. In this database, for example, the relationship between the retrieval information and the picture data is displayed with sequence numbers.

(a9) It is determined whether the state of the game at the time when the ‘data entry’ button is pressed is ‘awaiting the next delivery’, ‘change’, or ‘end of game’ (step S9).

If the ‘awaiting the next delivery’ state is entered, control is passed to step S5, and the processes in and after steps S5 through S8 are repeated.

(a10) If the ‘change’ state is entered in step S9, the ‘change’ button is pressed on the retrieval information input screen (FIG. 6) (step S10). Then, the defense and offense sides are switched on the retrieval information input screen, and the target player information (pitcher, catcher, batter) is fetched and automatically displayed (step S11).

Then, control is passed to step S5, and the operations in and after steps S5 through S8 are repeated.

(a11) If the ‘end of game’ state is entered in step S9, the ‘end of game’ button is pressed on the retrieval information input screen (FIG. 6) (step S12). Then, the retrieval information input screen is closed.

Finally, the entered file information is checked (step S13), and the recording process being performed by the video appliances (the video cameras 22 and 23, and the video deck 24) is terminated (step S14).

As described above, the picture capturing process and the retrieval information inputting process are terminated.

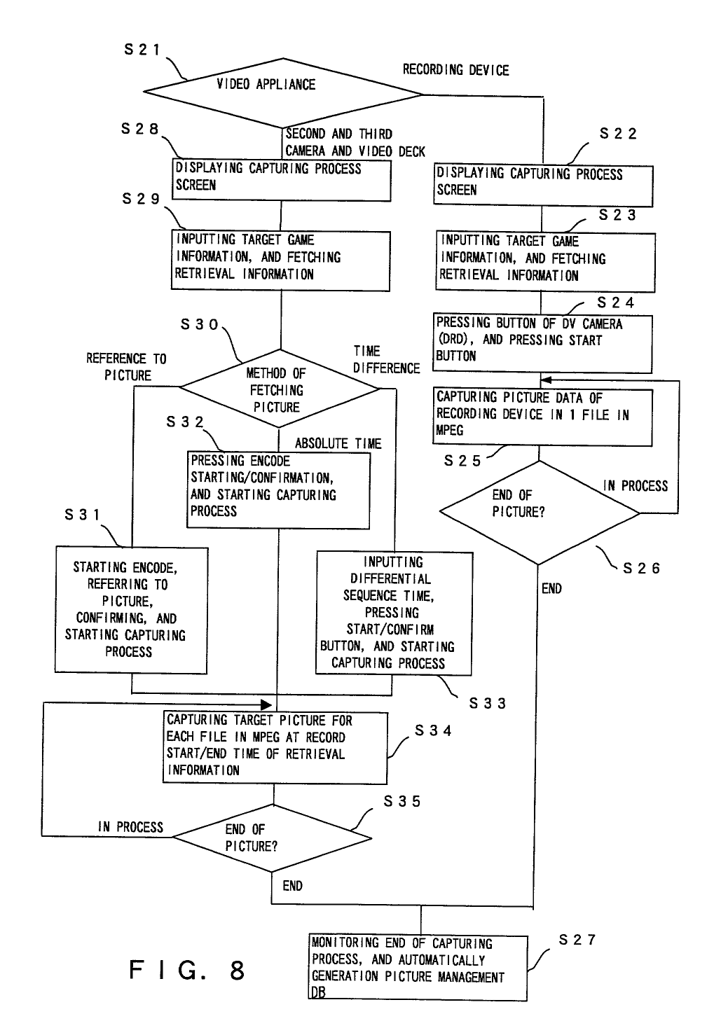

Then, as described in (b) above, a picture is captured and a database is generated using the personal computer 6 and the picture management server 11 for editing pictures as shown in (C) in FIG. 2. The procedure of the practical operations performed in the processes is described below by referring to FIG. 8.

(b1) First, it determines whether the picture data to be processed in the capturing operation has been obtained by the recording device (DRD) 26 or by other video appliances (the second and third video cameras 22 and 23, and the video deck 24) (step S21).

(b2) In the above mentioned step S21, if the picture data is obtained by the recording device (DRD) 26, the capturing process screen is displayed on the personal computer 6 (in (D) in FIG. 2) (step S22).

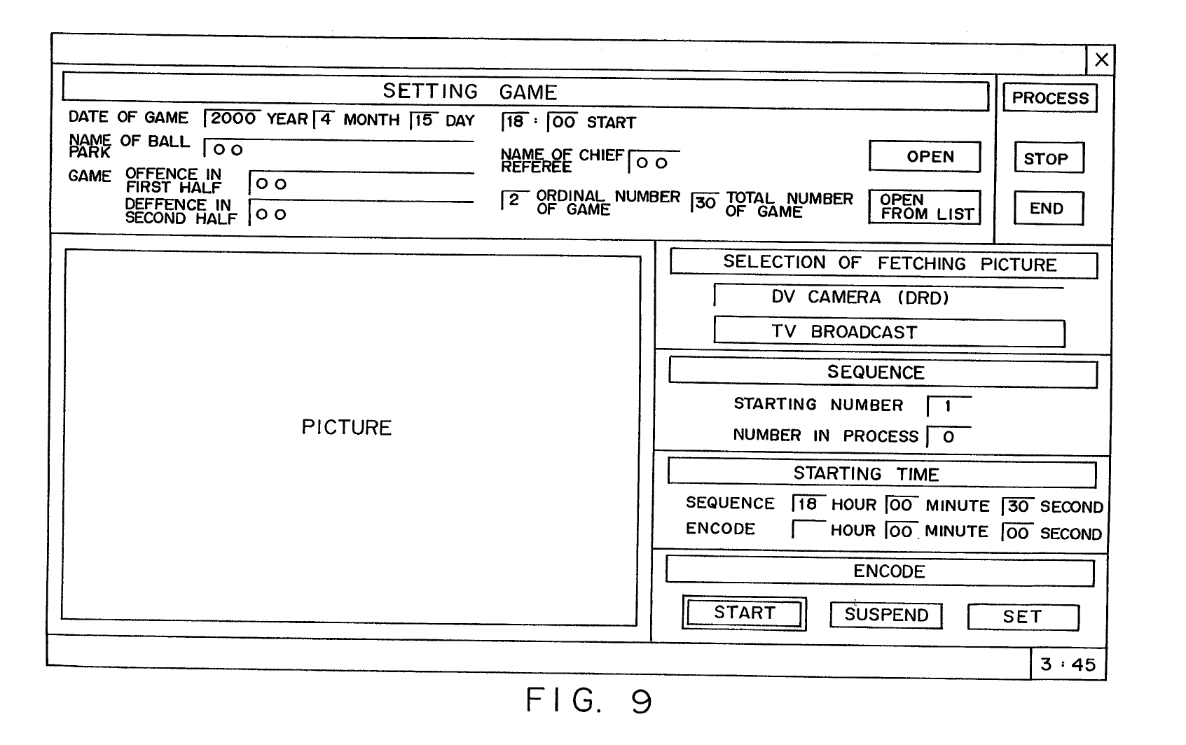

FIG. 9 shows an example of the above mentioned capturing process screen. The features of the screen are briefly described below.

If a game is performed, the ‘date of game’ and the ‘total number of games’ are input with the retrieval information entered (step S8 shown in FIG. 4), and the ‘open’ is clicked, then the retrieval information is read, and the ‘starting time of game’, ‘name of ball park’, ‘name of opposing team’, ‘name of chief referee’, and ‘ordinal number of the game’ are automatically displayed.

In the ‘open from a list’ process, a list of games currently accumulated on the hard disk is displayed, and a game to be read from the list is selected and read.

The ‘encode’ (capturing) process is continuously performed to the end once it is started. The process can be automatically performed without an operator.

The image in the encoding process is displayed in the monitor display column on the left.

When the encoding operation is suspended without continuously performing to the end of the sequence, the ‘stop’ button in the ‘process’ column is pressed. Thus, when the sequence in the current encoding process terminates, the process temporarily terminates.

When the encoding process is performed, it is determined whether the picture data of the recording device (DRD) is encoded or the pictures of other video appliances are encoded.

The sequence number is specified for the encoding process. The sequence number indicates the relationship between the retrieval information and the picture data (FIG. 7). When a sequence number is specified, the starting time at which the picture data corresponding to the sequence number is recorded is automatically displayed in the sequence’ column of the ‘starting time’ column. Immediately after opening the data, No. 1 is automatically selected as a sequence number.

When the picture data of the recording device (DRD) is encoded, the IDV camera (DRD) in the ‘selecting fetch of picture’ column is first selected, and then the ‘start’ in the ‘encode’ column is selected. According to the data entered in the retrieval information, the DRD pictures are sequentially called and captured.

When picture data (especially the picture data being received on TV) other than the data of the recording device is encoded, the time at which the ‘start’ button is pressed is set in the ‘encode’ column of the ‘starting time’ column. The time value is specified as a value smaller than the starting time of the sequence by a value equal to or longer than 5 seconds.

Since the date and time is recorded in a tape format when they are recorded on a DV video deck, they are displayed on the screen, the tape is read more than 5 seconds before the time set at the encode start time, and the ‘start of encode’ button is pressed at the input start of encode time. Then the timing of the encoding process can be correctly set. The actual encoding process is performed at the sequence starting time.

When the encoding process is suspended, the ‘suspend’ button is pressed.

When the encoding process is completed, a predetermined holder is generated in a directory to be shared with the database server (the drive mapping is completed when the system is activated), and data is transmitted. When the data transmission is completed, a data entry file is generated.

(b3) When the capturing process screen is displayed, the game information (date of game, total number of games) about the picture data to be captured is input, and the corresponding retrieval information is fetched from the floppy disk 2a (in (A) in FIG. 2), etc. (step S23). The fetched retrieval information is stored in a predetermined holder of the picture management server 11 (in (C) in FIG. 2).

(b4) After the ‘DV camera (DVD)’ is selected on the above mentioned capturing process screen, the ‘start’ button for encoding is pressed (step S24).

Then, each piece of picture data (picture data sectioned for each of the desired scenes) of the recording device (DVD) is sequentially captured in one animation file in the MPEG 1 format (step S25), and the process is performed until all picture data has been completely captured (step S26). The animation file is stored in a predetermined holder of the picture management server 11 (in (D) in FIG. 2).

(b5) Finally, when the capturing process is completed as described above, the retrieval information fetched in step S23 is associated with the animation file obtained in steps S25 and S26, and a picture database (picture management database) is generated (step S27).

First, to perform the operation, the ‘picture management database generation start’ button displayed on the personal computer 6 (in (C) in FIG. 2) is pressed. Then, the picture entry screen is displayed on the editing personal computer 6, and the picture database can be automatically generated according to the retrieval information and animation file.

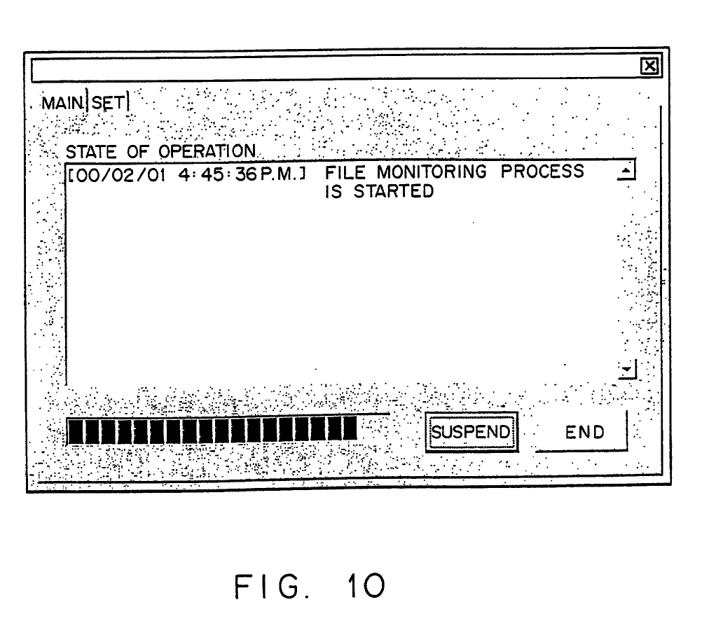

FIG. 10 shows an example of the above mentioned picture entry screen (main screen). On the picture entry screen, it can be monitored whether or not an image file has been written in the predetermined picture holder.

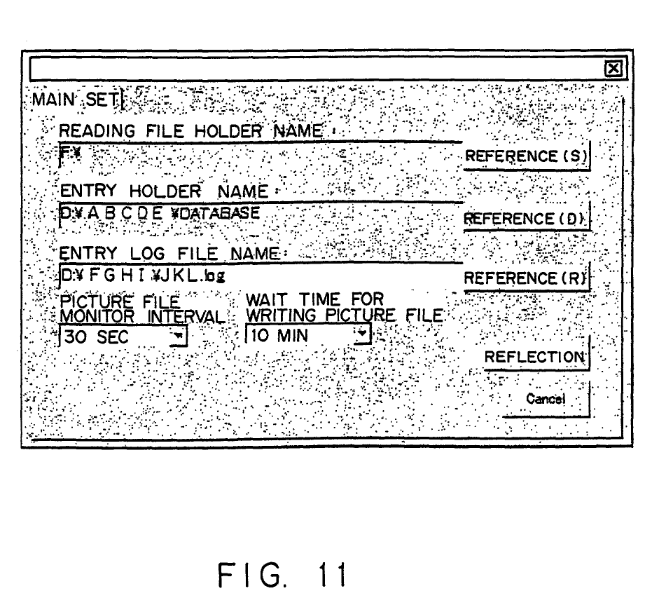

A picture holder, etc. to which an image file is written is set on the picture entry screen (initialization screen) as shown in FIG. 11. A ‘read file holder’ is a holder in which a image file to be entered is generated. An ‘entry holder’ is a holder for storing pictures. An ‘entry log file name’ is the name of a file for storing an operation history. A ‘picture file monitor interval’ is an interval at which it is checked whether or not an image file (picture file) has been completed in the reading file holder’. A ‘wait time for writing picture file’ is the maximum time (for example, 4 hours) in which the present program continuously monitors a ‘reading file holder’.

(b6) On the other hand, if picture data is obtained from video appliances (the video cameras 22 and 23, or the video deck 24 for recording TV program in real time) other than the recording device (DRD) in step S21, then the capturing process screen is displayed on the personal computer 6 (in (C) in FIG. 2) (step S28). This capturing process screen is the same as the capturing process screen displayed in step S22.

(b7) When the capturing process screen is displayed, the game information (the date of game, and the total number of games) about the picture data to be captured is input, and the corresponding retrieval information is fetched from the floppy disk 2a (in (A) in FIG. 2), etc. (step S29). The fetched retrieval information is stored in a predetermined holder of the picture management server 11 (in (C) in FIG. 2).

(b8) Since the picture data obtained by the video appliances other than the recording device (DRD) is continuous picture data not segmented for each of the desired scenes, it is necessary to fetch only the portion corresponding to the picture data segmented for each of the desired scenes obtained by the recording device (DRD) to store the picture data obtained by the video appliances other than the recording device as a database. Therefore, one of the three methods, that is, ‘referring to a picture itself’, ‘referring to an absolute time’, and ‘referring to a time difference’, is selected as a method of fetching picture data (step S30).

(b9) In step S30, when the method of referring to a ‘picture itself’ is selected, the ‘start’ button for encoding is pressed on the capturing process screen (FIG. 9), and the capturing process is started by pressing the ‘confirmation’ button while referring to the picture displayed on the monitor display column on the left (step S31).

(b10) In step S30, when the method of referring to an ‘absolute time’ is selected, the capturing process is started at an absolute input time at which the encoding process is started on the capturing process screen (FIG. 9) by pressing the ‘start’ button and the ‘confirmation’ button (step S32).

(b11) In step S30, when the method of referring to a ‘time difference’ is selected, the capturing process is started at a time based on an input time difference, which is a differential sequence time, on the above mentioned capturing process screen (FIG. 9) by pressing the ‘start’ button and the ‘confirmation’ button (step S33).

(b12) After starting the capturing process when any fetching method is selected in step S30, the target picture data is segmented and extracted for each of the desired scenes at the ‘record starting time’ and the ‘record ending time’ of the retrieval information. Furthermore, the capturing process is performed on one animation file in the MPEG 1 format (step S34), and the process continues until all picture data is completely captured (step S35). The animation file is stored in a predetermined holder of the picture management server 11 (in (C) in 2).

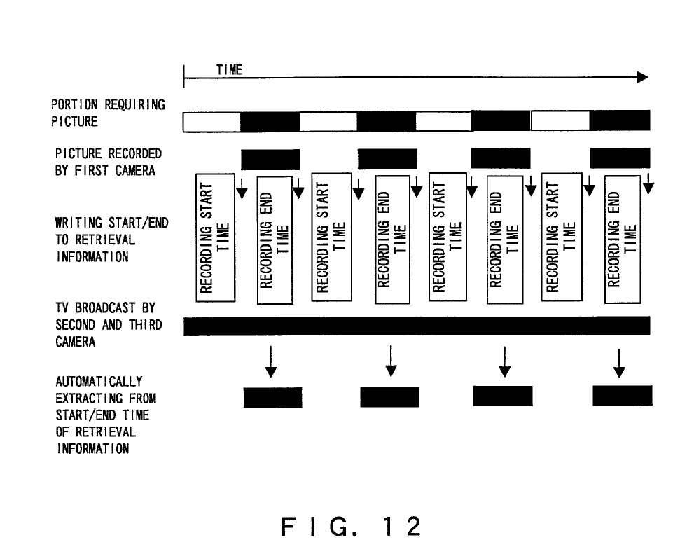

FIG. 12 shows a general concept of the process of entering a picture by automatically segmenting it by a plurality of video appliances.

(b13) When the capturing process is completed, the retrieval information fetched in step S29 is associated with the animation file obtained in steps S34 and S35, and a picture database (picture management database) is generated (step S27).

As described above, the picture capturing process and the database generating process are completed on all picture data obtained by each of the video appliances.

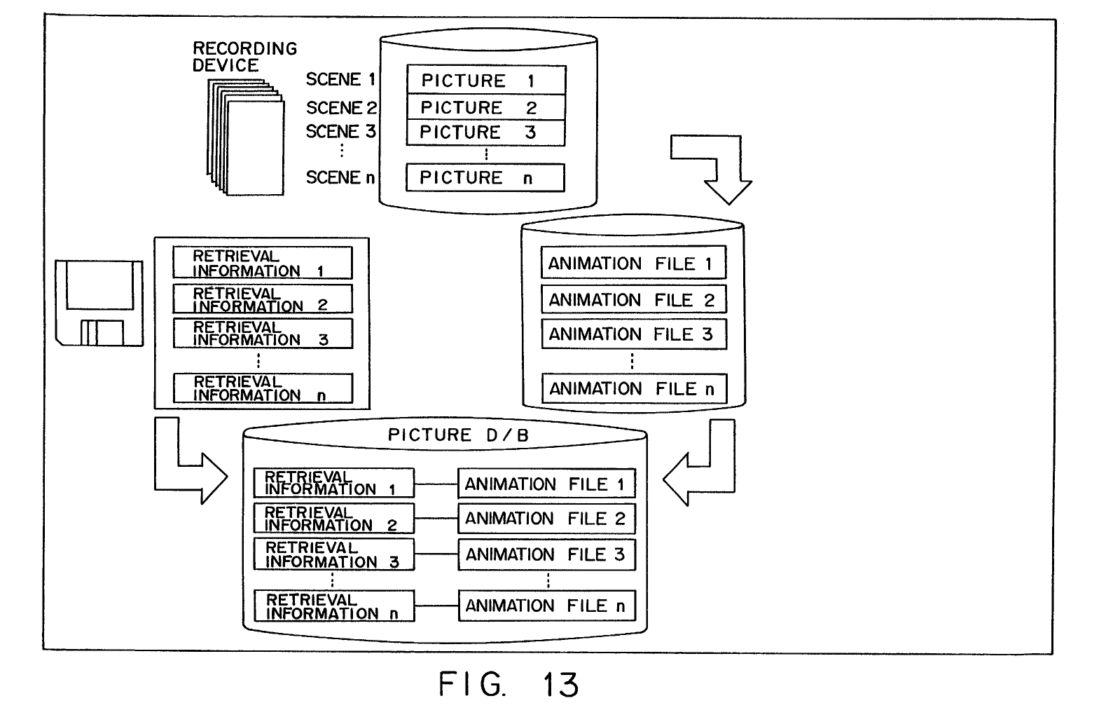

For information, FIG. 13 shows an outline of the transition image of the data structure from the picture capturing process to the database generating process. As apparent in FIG. 13, each of the picture data 1 through n of each of the desired scenes (for each delivery) obtained by recording by the recording device is separated from each other, segmented, and converted into animation files 1 through n in the MPEG 1 format, and is then associated with each of the retrieval information 1 through n input for each piece of the picture data, and stored in the picture database (D/B).

In this example, when there are plural pieces of picture data captured from a subject from a plurality of directions although not shown in the attached drawings, each step shown in FIG. 8 is performed for each piece of data. In this case, the picture database (D/B) shown in FIG. 13 stores a piece of retrieval information associated with a plurality of animation files. For example, retrieval information 1 is associated with an animation file 1-1 (a picture from the backstop), an animation file 1-2 (a picture from the first base side), and the animation file 1-3 (a picture from the third base side).

The obtained picture database is, as shown in FIG. 1, stored in the CD-ROM and a picture can be retrieved and viewed, or a picture can be retrieved and viewed through Internet.

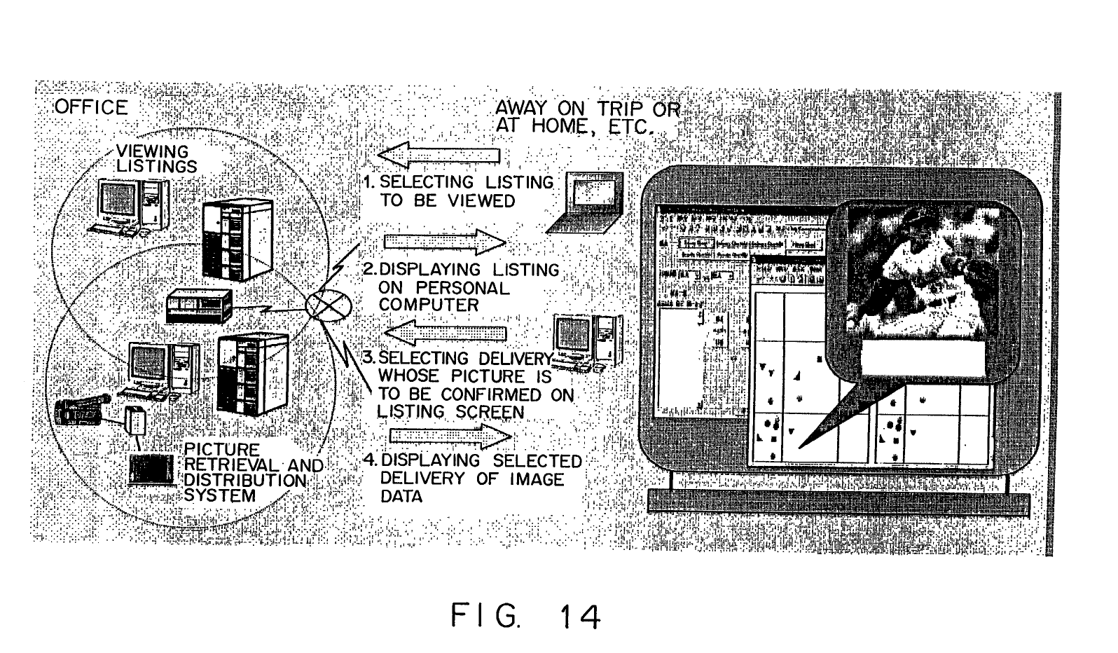

Furthermore, a system (hereinafter referred to as a listing viewing system) in which the score information about a baseball game, an analysis result, etc. of the game can be stored as a database as listing data in advance, and a listing to be viewed is selected through a network and displayed on the screen has been developed. The above mentioned picture data retrieval and distribution system cooperates with the listing viewing system to, for example, display the picture data only by specifying the delivery of a ball in the listing away on a trip or from home as shown in FIG. 14. That is, for example, 1. a listing to be viewed is selected, 2. the listing is displayed on a personal computer, 3. a delivery whose picture is to be confirmed on the listing screen is selected, and 4. image data of the selected delivery is displayed.

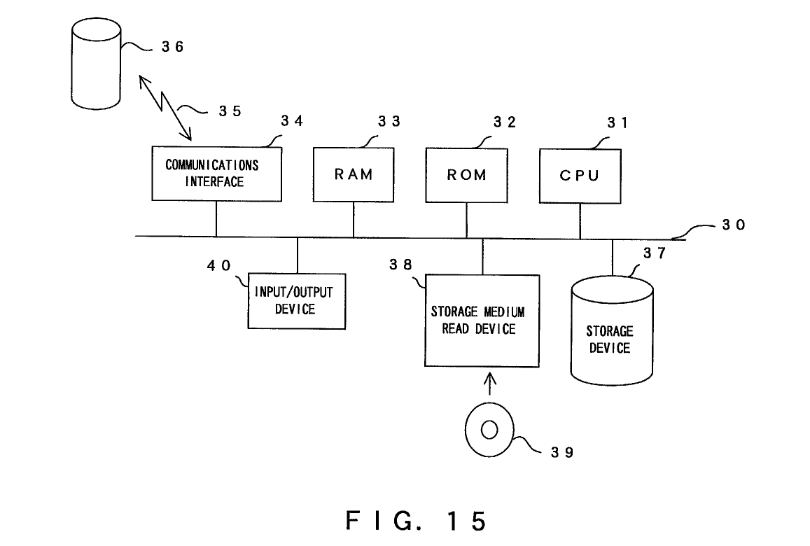

FIG. 15 shows an example of the hardware configuration required when the present invention is realized by a program (software).

When the present invention is realized by a program, a typical device for executing the program can be configured by each device (ROM 32, RAM 33, a communications interface 34, a storage device 37, a storage medium read device 38, and an input/output device 40) connected to a CPU 31 through a bus 30. The ROM 32 stores a BIOS (basic input/output system), etc. When the power is applied to the device, the CPU 31 gains access to the ROM 32, the CPU 31 reads the BIOS, and each device can be controlled.

It is possible for the ROM 32 to store a program for realizing the present invention. Otherwise, the program is stored in the storage device 37, and is developed in the RAM 33 so that the CPU 31 can execute the program. In addition, the program can be stored in a portable storage medium 39, the storage medium read device 38 reads the program stored in the portable storage medium 39 to the RAM 33, and the CPU 31 can execute the program. Furthermore, the program stored in the portable storage medium 39 can be temporarily stored in the storage device 37, and then the CPU 31 executes the program.

Otherwise, the system can be connected to a network such as Internet, etc. using the communications interface 34 so that the program can be downloaded from an information provider 36. Furthermore, the program can also be executed without download through the network 35, or without download under the network environment.

As described above, the present invention is applicable to various picture data. For example, when the present invention is applied to soccer games, a ‘subject’ is a player before or after scoring a goal (including a set play such as a PK, etc.), and a ‘play state’ includes a player relating to a score, an assistant, a goalkeeper, a goal time (first half or second half), a position at which a ball is shot, and a storing state. The type of shot can include a straight, right curve, and left curve. The ‘course of shot’ includes the course of a successful shot (left/center/right information and high/center/low information). In other ball games and sports, the rules and the features of ball games and sports can be similarly changed.

When the present invention is applied to a fashion show, the ‘attribute’ can contain any of, a combination of, or all of a brand name, a designer name, a place of a show (for example, Paris, Milan, or New York), a place of a show (for example, an ABC building), the date of a show (date of Anno Domini and the seasons of spring, summer, autumn, and winter), the order of appearance, the name of music in the background.

An embodiment of the present invention has been described above, but it is obvious that the present invention is not limited to this embodiment. Various configurations can be applied within a range of the gist of the present invention.

According to the present invention, a database can be generated by associating the picture data for each desired scene with various retrieval data relating to the picture data. Therefore, using the database, only the desired picture data satisfying a retrieval condition can be immediately retrieved and viewed only by determining the retrieval condition as necessary.

If the above mentioned system according to the present invention is used for support of a baseball team, etc., any player of the team can positively and actively use the system with the greatest contribution to the team.

What is claimed is:

1. A data processing device, comprising:
an input unit inputting segmentation information indicating a time slice for each piece of picture data continuous in time series about a subject, and retrieval data indicating an attribute of the subject corresponding to each piece of picture data assigned to each time slice; and
a storage unit segmenting the continuous picture data according to the segmentation information, associating each piece of picture data obtained by segmenting the data with the corresponding retrieval data, and storing the associated data.

2. The device according to claim 1, wherein
said subject is a player of a ball game being performed, and said retrieval data contains information about a delivery of a ball.

3. The device according to claim 1, wherein
said subject is a player of a ball game being performed, and said retrieval data contains information about a course of a ball.

4. The device according to claim 1, wherein
said subject is a player of a ball game being performed, and said retrieval data contains information about a play state in the play of the ball game.

5. The device according to claim 1, wherein
said segmentation information comprises a record starting time and a record ending time which are absolute times.

6. The device according to claim 5, wherein
said subject is a player of a ball game being performed, and said record starting time and said record ending time are a record starting time and a record ending time for each delivery of a ball.

7. A data processing device, comprising:
an input unit inputting common segmentation information indicating a time slice common to plural different pieces of picture data continuous in time series about a subject, and retrieval data indicating an attribute of the subject corresponding to each piece of picture data assigned to each time slice; and
a storage unit segmenting the plural pieces of continuous picture data according to the common segmentation information, associating each piece of picture data obtained by segmenting the data with the corresponding retrieval data, and storing the associated data.

8. The device according to claim 7, wherein
said plural pieces of continuous picture data are different from each other and obtained by capturing the subject from plural directions.

9. The device according to claim 7, wherein
said subject is a player of a ball game being performed, and said retrieval data contains information about a delivery of a ball.

10. The device according to claim 7, wherein
said subject is a player of a ball game being performed, and said retrieval data contains information about a course of a ball.

11. The device according to claim 7, wherein
said subject is a player of a ball game being performed, and said retrieval data contains information about a play state in the play of the ball game.

12. The device according to claim 7, wherein
said segmentation information comprises a record starting time and a record ending time which are absolute times.

13. The device according to claim 12, wherein
said subject is a player of a ball game being performed, and said record starting time and said record ending time are a record starting time and a record ending time for each delivery of a ball.

14. A computer-readable storage medium storing a computer program for processing picture data, said computer program comprises:
an input unit inputting retrieval data about picture data continuous in time series about a subject, the retrieval data containing segmentation information indicating a time slice for each piece of the picture data; and
a storage unit segmenting the continuous picture data according to the segmentation information, and storing the segmented picture data after being associated with the retrieval data.

15. A computer-readable storage medium storing a computer program for processing picture data, said computer program comprises:
an input unit inputting retrieval data about plural different pieces of picture data continuous in time series about a subject, the retrieval data containing common segmentation information indicating a time slice common to the plural different pieces of picture data; and
a storage unit segmenting the continuous picture data according to the common segmentation information, and storing the segmented picture data after being associated with the retrieval data.
